(19) United States
(12) Patent Application Publication
(10) Pub. No.: US 2005/0211915 A1
(43) Pub. Date: Sep. 29, 2005

(54) Probe for an atomic force microscope and method for making such a probe

(75) Inventors: Arnout Gerbrand Van den Bos, Hengelo (NL); Leon Abelmann, Enschede (NL); Jacobus Christiaan Lodder, Enschede (NL)

Correspondence Address: DARBY & DARBY P.C., P. O. BOX 5257, NEW YORK, NY, 10150-5257, US

(73) Assignee: Stichting voor de Technische Wetenschappen, Utrecht (NL)

(21) Appl. No.: 10/499,174

(22) PCT Filed: Dec. 18, 2002
(86) PCT No.: PCT/NL02/00842

§ 371 Date: May 11, 2005

(30) Foreign Application Priority Data
Dec. 21, 2001 (NL) 1019638

(51) Int. Cl. G01T 1/04

(52) U.S. Cl. 250/472.1

(57) ABSTRACT

The invention relates to a probe for a magnetic force microscope, comprising a movable cantilever placed in the plane of a wafer and a tip placed substantially at right angles to the cantilever, wherein the cantilever is able to move and its oscillation direction is in the wafer plane, and the tip lies virtually in or parallel to this wafer plane.

The invention relates to a probe for a magnetic force microscope (a so-called “MFM”), comprising a movable cantilever placed in the plane of a wafer and a tip placed substantially at right angles to the cantilever.

The invention also relates to a method for fabricating such a generally known probe for a magnetic force microscope, wherein a cantilever is provided in the plane of a wafer and a tip is applied on the cantilever.

The fabrication of such a generally known probe is difficult. This is partly attributable to the high aspect ratio striven for with the tip. Normally the tip is placed perpendicularly on the wafer plane on the cantilever. To this end the known tip usually has a pyramidal form. The oscillation direction of the cantilever of the prior art probe is perpendicular to the wafer plane. After positioning, the tip is provided with a thin magnetic coating in order to render the probe suitable for use with a magnetic force microscope. The pyramidal tip falls short of the ideal shape, forming a limitation to the imaging resolution when using the probe.

A method for fabricating a probe for a magnetic force microscope is known from the article by Ried R. P. et al.: 6-MHZ 2-N/M Piezoresistive Atomic-Force-Microscope Cantilevers with Incisive Tips, Journal of Microelectromechanical Systems, IEEE Inc. New York, US, vol. 6, no. 4, 1 Dec. 1997 (1997-12-01), pages 294-302, XP000779954 ISSN: 1057-7157. In this known method and probe a cantilever is provided in the plane of a wafer and a tip is applied on the cantilever which can be provided with a magnetic film to render it suitable for magnetic force microscopy.

The object of the invention is to simplify the fabrication of the probe referred to in the preamble, and to improve the resolution possible with such a probe. To this end the method for fabricating such a probe for a magnetic force microscope is characterized, in that substantially in the wafer plane, on the cantilever a free-hanging thin film is provided which lies substantially at right angles to the cantilever, and which forms a base plane of the tip. The probe fabricated by this method is preferably characterized, in that the cantilever is able to move and its oscillation direction is in the wafer plane, and that the tip lies virtually in or parallel to this wafer plane.

The fabrication of a probe for the magnetic force microscope may conveniently be completed such that by means of thin-film deposition a thin-film magnetic coating is provided on the surface of the free-hanging thin film. This makes the dimensions of the probe according to the invention very controllable.

The invention will hereinafter be further elucidated with reference to the drawing.

The drawing shows in:

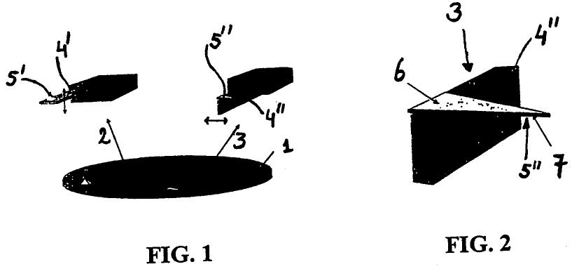

FIG. 1 schematically and next to each other a probe according to the prior art and a probe according to the invention; and

FIG. 2 a probe according to the invention on an enlarged scale.

Similar parts in the figures are identified by the same reference numbers.

Referring first to FIG. 1, a wafer 1 is shown incorporating in the plane of the wafer a probe 2 according to the prior art, and a probe 3 according to the invention. Both the probe 2 according to the prior art and the probe 3 according to the invention are embodied with a cantilever 4′ and 4″, respectively. The cantilever 4′ of the probe 2 according to the prior art is movable at right angles to the plane of the wafer 1, whereas the cantilever 4″ of the probe 3 according to the invention is movable in the plane of the wafer 1.

The probe 2 according to the prior art is completed with a pyramidal tip 5′ placed on the cantilever 4′, which tip is provided with a magnetic coating.

The cantilever 4″ of the probe 3 according to the invention is provided with a tip 5″, which is provided as explained with reference to FIG. 2.

FIG. 2 shows the probe 3 according to the invention in more detail. As already mentioned, the oscillation direction of the cantilever 4″ of this probe 3 is in the plane of the wafer 1 and concurrently, the tip 5″ is also provided in the plane of the wafer 1. For the fabrication of the tip 5″ a free-hanging thin film 6 is applied in the plane of the wafer 1 and on the cantilever 4″, which forms the base plane of the tip 5″. To complete the tip 5″, the facing side (in the figure the side toward the front) of this base plane 6 is by means of thin-film deposition technique provided with a thin-film magnetic coating 7. Thus the dimensions of the tip 5″ that are of important relevance, are determined by the thickness of the base plane 6 and the thickness of the thin-film magnetic coating 7. Both the thickness of the base plane 6 and the thickness of the thin-film magnetic coating 7 can be controlled very well because they are applied by means of thin-film deposition techniques. The length of the base plane 6 can also be controlled very well because this is determined with the aid of known lithographic techniques.

The method according to the invention makes it possible to fabricate the tip 5″ on the cantilever 4″, so that the tip 5″ as much as possible corresponds to the ideal shape desirable for obtaining a high resolution during image recordings. Another advantage of the invention is that the method is very suitable to be used for series production with low failure percentages.

1. A probe (3) for a magnetic force microscope, comprising a movable cantilever (4″) placed in the plane of a wafer (1) and a tip (5″) placed substantially at right angles to the cantilever (4″), characterised in that the cantilever (4″) is able to move and its oscillation direction is in the wafer plane (1), and that the tip (5″) lies virtually in or parallel to this wafer plane (1).

2. A method for fabricating a probe (3) for a magnetic force microscope, wherein a cantilever (4″) is provided in the plane of a wafer (1) and a tip (5″) is applied on the cantilever (4″), characterised in that substantially in the wafer plane (1), on the cantilever (4″) a free-hanging thin film (6) is provided, which lies substantially at right angles to the cantilever (4″), and which forms a base plane of the tip (5″).

3. A method according to claim 2, characterised in that a thin-film magnetic coating (7) is provided on the free-hanging thin film (6) by means of thin-film deposition, to complete the tip (5″).
